(19) United States
(12) Patent Application Publication
(10) Pub. No.: US 2009/0150028 A1
(43) Pub. Date: Jun. 11, 2009

(54) Motor vehicle with a safety system with a preventive action

(75) Inventors: Werner Bernzen, Ehningen (DE); Dominic Reutter, Birenbach (DE); Alfred Wagner, Gomaringen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STRUTTGART (DE)

(21) Appl. No.: 11/659,090

(22) PCT Filed: Jul. 29, 2005
(86) PCT No.: PCT/EP2005/008241

§ 371 Date: Nov. 6, 2008

(30) Foreign Application Priority Data
Aug. 3, 2004 (DE) 10 2004 037 539.9

(51) Int. Cl. B60R 21/01

(52) U.S. Cl. 701/45

(57) ABSTRACT

In a motor vehicle, such as a passenger car, a preventive-action protection system is provided which includes safety devices that are actuated as a function of information detected by a driving-state sensor system and evaluated in a data evaluation and control device, which compares the detected information with at least one threshold value. When a critical condition of the driving state is detected, the data evaluation and control device actuates at least one safety device assigned to this driving state. Here, a theoretical, lateral-dynamics critical condition is detected and triggering of at least one assigned safety device occurs if a threshold value is exceeded when a current steering angle speed is logically combined with a parameter which represents the current driving-dynamics situation.

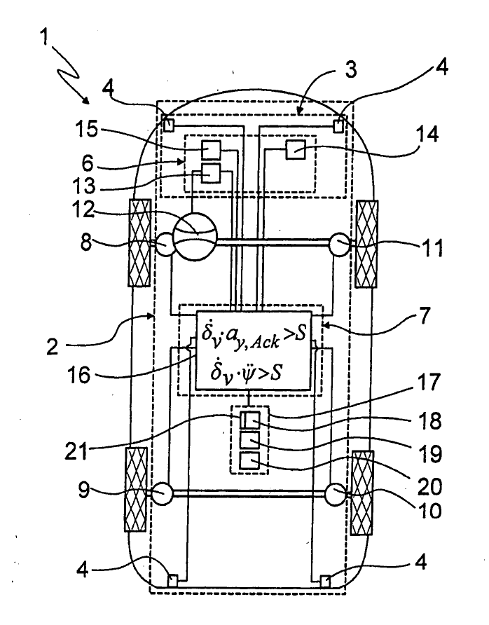

### CROSS REFERENCE TO RELATED APPLICATIONS

This application is a national stage of PCT International Application No. PCT/EP2005/008241, filed Jul. 29, 2005, which claims priority under 35 U.S.C. § 119 to German Patent Application No. 10 2004 037 539.9 filed Aug. 3, 2004, the entire disclosures of which are herein expressly incorporated by reference.

### BACKGROUND AND SUMMARY OF THE INVENTION

The present invention relates to a motor vehicle with a preventive-action protection system.

Motor vehicles, in particular passenger cars, are equipped with active and passive safety devices which permit the driver to control his vehicle better even in critical situations, and thus possibly avoid the vehicle being involved in an accident. If a collision occurs, such safety devices also help to reduce the severity of the accident.

Preventive safety devices, which are active before a possible collision and use a pre-crash phase, i.e., a period of time starting from the detection of a high probability of a collision by appropriate detection systems in the vehicle up to the actual impact, to enhance the vehicle occupant protection with additional safety measures and thus lessen the severity of an accident, are referred to as preventive-action protection systems or so-called PRE-SAFE™ systems.

To detect possible accident situations, preventive-action protection systems use information which is made available by various sensor devices of the motor vehicle. The sensor devices can be a component of an electronic driving stability program and/or a component of a distance sensor system. Depending on the detected situation, conclusions are drawn about a possible accident, and appropriate measures, relating to restraint systems for vehicle occupants and possible protection devices for other parties in an accident, such as pedestrians, are initiated to prepare the vehicle for the imminent accident.

German patent document DE 101 21 386 CI describes, for example, a method for actuating a reversible vehicle occupant protection means in a motor vehicle. The motor vehicle has a reversible vehicle occupant protection system which can be activated before a collision and thus placed in an active position. To do this, a sensor system is used to acquire driving state data which is monitored for possible emergency braking, possible oversteering and possible understeering. If emergency braking, oversteering and/or understeering is detected, the vehicle occupant protection system is activated, it being possible to trigger the vehicle occupant protection system only if a minimum velocity is exceeded. The sensor system for sensing the driving state data can include a steering angle sensor, a pedal travel sensor, a brake pressure sensor, a wheel speed sensor, an acceleration sensor and a yaw rate sensor.

In the vehicle occupant protection system known from German patent document DE 101 21 386 C1, restraint systems are thus activated after a critical change in the driving state has been detected, and displacement of vehicle occupants may thus already have occurred. In particular, at high coefficients of friction, which result in high longitudinal and lateral acceleration values of the vehicle, vehicle occupants may have already been unfavorably displaced by the time the restraint systems become effective.

An object of the present invention is to provide a vehicle with a preventive-action protection system which prevents displacement of a vehicle occupant as early as possible.

In a motor vehicle with a preventive-action protection system, a data evaluation and control device compares the information picked up from a driving-state sensor system with at least one threshold value. When a critical condition of the driving state is detected, the data evaluation and control device actuates at least one safety device assigned to this driving state, in which a theoretical lateral-dynamics critical condition is detected and at least one assigned safety device is triggered, if a threshold value is exceeded, when a current steering angle speed is logically combined with a parameter representing the current driving-dynamics situation. The motor vehicle has the advantage that steering movements which can cause a driving situation that is critical in terms of lateral dynamics, and which justify triggering of reverse vehicle occupant protection systems, are detected early so that suitable safety devices are triggered before appreciable longitudinal acceleration of the vehicle, and in particular lateral acceleration of the vehicle, displaces the vehicle occupants.

Thus, for example, when the assigned safety device is a reversible seatbelt pretensioner and there is a critical steering maneuver with an inappropriate fast steering movement and skidding of the vehicle which is to be expected in view of the current driving-dynamics situation, it is possible for the motor vehicle occupant to be conditioned for the skidding process before displacement of the vehicle occupant occurs due to lateral acceleration of the vehicle.

In this context, the triggering of the safety devices can be parameterized in such a way that, for example, when the vehicle skids with a low coefficient of friction and the vehicle occupants are not displaced, or are only displaced insignificantly, due to low forces of mass inertia, slower or less powerful conditioning of the vehicle occupants occurs than when the vehicle skids with a high coefficient of friction and there is a correspondingly high degree of anticipated displacement of the vehicle occupant.

With the actuation of the assigned safety devices as a function of the steering movement and the current driving-dynamics situation, not only is the safety of the vehicle occupants increased because displacement of the vehicle occupants is prevented from the outset, but also the feeling of comfort of the vehicle occupants is also enhanced.

In one exemplary embodiment of the present invention, a yaw rate or a yaw acceleration can serve as a parameter which represents the current driving-dynamics situation. In such a context, a theoretical lateral-dynamics critical condition can be detected if the product of the steering angle speed and the yaw acceleration is greater than a predefined threshold value.

The predefined threshold may be defined as a function of the vehicle velocity, the real lateral acceleration, the coefficient of friction and further suitable influencing variables.

Alternatively, the parameter which represents the current driving-dynamics situation can also be a theoretical lateral acceleration according to Ackermann, referred to as an Ackermann lateral acceleration. A theoretical lateral-dynamics critical condition can again be considered to be detected here if the product of the steering angle speed and the Ackermann lateral acceleration is greater than the predefined threshold value.

In one exemplary embodiment of the invention, a detected critical condition of the driving state cannot only be understood to be a driving state which is highly probable to lead to the vehicle being involved in an accident, but also a driving state which is brought about with a sporty driving behavior and in which the actuation of suitable safety devices is appropriate to increase the comfort of the vehicle occupants. Thus, for example, when cornering, the vehicle occupant can be slightly pulled into the seat and as a result better supported on the sides, as a result of which upholstered elements of the vehicle seat are loaded better and integrated into the process of securing the vehicle occupant.

Basically, the actuation of safety devices according to the invention is suitable for all safety devices provided in a vehicle, which safety devices can be, for example, a reversible seatbelt pretensioner, an electric seat adjustment device, restraining upholstered elements which can be adjusted in terms of their shape, size and/or position, in particular knee upholstered elements, or other vehicle components which can be adjusted electrically, hydraulically or pneumatically with a view to increasing safety.

The driving-state sensor system can include a sensor system which is configured in a variety of ways and which is equipped, for example, with a steering wheel sensor, a pedal travel sensor, a brake pressure sensor, a wheel speed sensor, an acceleration sensor, a yaw rate sensor and/or a distance sensor.

The data evaluation and control device of the preventive-action protection system can be a data processing device of a driving stabilization system of the motor vehicle which may be present in modern vehicles. Of course, alternatively, a separate data processing device can also be used.

The actuation of the respective safety device can be made more precise and adapted to the respective situation if it is carried out as a function of determined physiological variables of a vehicle occupant. These include, in particular, the size of vehicle occupants and their weight. This data can be determined by a weight detection device which is connected to the data evaluation and control device and a body size detection device, it being possible for the weight detection device to be embodied so that it is integral with the seat occupation detection device, and the body size detection device can be embodied so that it is integral, for example, with a seat position sensor system and for example, an optical head position determination device.

With such devices, which are to a certain extent already installed on a series production basis, it is possible to determine the position of a vehicle occupant in the vehicle, which information can also be used to actuate the safety device in exemplary embodiments of the invention.

The vehicle velocity or a gradient of the vehicle velocity are important input signals for controlling safety devices. In this context, it is possible for certain safety devices to be activated only after a certain vehicle speed occurs, and for the actuation of its actuators to last until the vehicle speed has reached a very low value of, for example, 3 km/h.

In order to detect a lateral-dynamics critical driving situation such as understeering (during which the radius of the setpoint path predefined by the steering angle is smaller than the radius of the path actually traveled through by the vehicle), or oversteering (during which the radius of the setpoint path predefined by the steering angle is greater than the radius of the path actually traveled through), the total acceleration of the vehicle which is determined by corresponding acceleration sensors, and if appropriate, by a yaw sensor, and which results from the sum of the vehicle longitudinal acceleration and the vehicle lateral acceleration, may be analyzed. If the analysis reveals that the triggering threshold value which varies as a function of the coefficient of friction is exceeded, the data evaluation device outputs a collision possibility so that the safety devices which interact with the preventive-action protection system are activated and conditioned in accordance with the possible accident situation.

The steering can be used both as a single variable which triggers corresponding safety devices but also other known triggering devices, such as are described, for example, in German patent document DE 101 21 386 Cl. The actuation according to the invention can thus serve as software expansion of known actuation means for safety devices.

Other objects, advantages and novel features of the present invention will become apparent from the following detailed description of the invention when considered in conjunction with the accompanying drawings.

### BRIEF DESCRIPTION OF THE DRAWINGS

The FIGURE illustrates an exemplary embodiment of a motor vehicle which is configured according to the invention.

### DETAILED DESCRIPTION OF THE DRAWINGS

The FIGURE shows a schematic plan view of a motor vehicle 1 which can be embodied as a passenger car or else as a utility vehicle and which is equipped with a preventive-action protection system 2.

The preventive-action protection system 2 has a safety sensor system 3 which includes a vehicle surrounding detection device 4 and a driving-state sensor system 6. The driving-state sensor system 6 is configured to sense longitudinal dynamic and lateral dynamic driving state information, inter alia to detect emergency braking and panic braking, oversteering and/or under-steering of the motor vehicle 1.

For these purposes, use is made, inter alia, of information or data supplied by wheel speed sensors 8, 9, 10 and 11, by a steering angle δᵥ, arranged in the region of a steering wheel 12 and a sensor 13 which senses the steering angle speed (\dot{δ}ᵥ), a longitudinal acceleration sensor 14 and a lateral acceleration sensor 15.

The driving-state sensor system 6 communicates here with a driving dynamics functionality 7 such as an antilock brake system and/or an electronic stability program into which a data evaluation and control device 16 of the preventive-action protection system 2 is integrated.

During normal operation of the motor vehicle, the driving-state sensor system 6 can, for this purpose, analyze further important driving dynamics variables such as a vehicle velocity v_{F}, a yaw acceleration \ddot{Ψ}, a spring compression travel and spring extension travel, the level of the vehicle, an accelerator pedal movement, an accelerator pedal position, a brake pedal position, a brake pedal movement and, in addition to the steering angle δᵥ and the steering angle speed \dot{δ}ᵥ, a steering angle acceleration. In this context, actual values of these variables are compared with predefined setpoint values and threshold values.

The information determined by the driving-state sensor system 6 and the setpoint/actual value comparisons serves to activate known systems such as the antilock brake system and/or the electronic stability program which have the function of supporting the driver of the motor vehicle in critical driving situations in order to avoid an accident.

Furthermore, in order to activate the preventive-action protection system 2 and its safety devices 17 early in the event of a driving situation which is expected to be critical in terms of lateral dynamics, a data reconciliation takes place in the data evaluation and control device 16. A theoretical lateral-dynamics critical condition may be detected and the correspondingly assigned safety devices 17 may be triggered if, when the current steering angle speed \dot{δ}ᵥ is logically combined with a parameter representing the current driving-dynamics situation, a threshold value S is exceeded.

A triggering algorithm according to the invention which is provided for the safety devices 17 and which is stored in the data evaluation and control device 16 provides here for the parameter which represents the current driving-dynamics situation to be the yaw acceleration \ddot{Ψ}.

If the product of the steering angle speed \dot{δ}ᵥ and the yaw acceleration \ddot{Ψ}, is greater than the predefined threshold value S, a theoretical lateral-dynamics critical condition is detected and the safety devices 17 are actuated.

The safety devices may include a reversible seatbelt pretensioner 18, restraining upholstered elements 19 and an actuator for actuating an electrical seat adjustment device 20. The vehicle seats or their components may be placed, as a function of their occupation, in an orientation which supplies the greatest possible safety when the respective vehicle occupant is expected to be displaced.

In order to check plausibility a further algorithm may be run through, which algorithm which can also be used alone, as an alternative to the previously described algorithm which logically combines the steering angle speed \dot{δ}ᵥ with the yaw acceleration \ddot{Ψ}.

In this further algorithm, the parameter which represents the current driving-dynamics situation is an Ackermann lateral acceleration a_{y,Ack}, which is determined according to the formula

$${a}_{y , Ack} = {v}_{F}^{2} \cdot \frac{{δ}_{v}}{{L}_{F}}$$

with the vehicle velocity v_{F}, the steering angle δᵥ, and the wheel base L_{F}.

If the product of the steering angle velocity \dot{δ}ᵥ and the Ackermann lateral acceleration a_{y,Ack} is greater than the predefined threshold value S, a theoretical lateral-dynamics critical condition and thus a plausibility check of the actuation of the reversible seatbelt pretensioner 18 is again detected.

The threshold value S is in each case a function of the vehicle velocity v_{F} and/or of a gradient of the velocity, a coefficient of friction of the roadway, of a determined lateral acceleration and, if appropriate, of further suitable parameters.

In addition to this triggering algorithm for the reversible seatbelt pretensioner 18 which intervenes before displacement of the vehicle occupant, the data evaluation and control device 16 also carries out plausibility checking of all the input and ambient data in a conventional way if there is information indicating that a longitudinal-dynamics critical situation of the current driving state, which corresponds, for example, to emergency braking or panic braking, is present. Plausability checking may also be carried out if the data evaluation and control device 16 detects a lateral-dynamics critical condition of the driving state, for example, due to severe oversteering or understeering outside a range which can be corrected by the electronic stability program and outside the driving physics which can be controlled, with parametrically predefined release thresholds being correspondingly exceeded. If the data is plausible, the reversible seatbelt pretensioner 18 is activated.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-11. (canceled)

12. In a motor vehicle, a preventive-action protection system comprising:
a driving state sensor system;
safety devices which are actuated as a function of information detected by the driving state sensor system; and
a data evaluation and control device configured to compare the detected information with at least one threshold value and, when a critical condition of a driving state is detected, actuate at least one safety device assigned to the driving state,
wherein a theoretical, lateral-dynamics critical condition is detected and the at least one assigned safety device is triggered, if a predefined threshold value is exceeded when a current steering angle speed is logically combined with a current driving-dynamics parameter.

13. The preventive-action protection system as claimed in claim 12, wherein the current driving-dynamics parameter is a yaw rate or yaw acceleration.

14. The preventive-action protection system as claimed in claim 13, wherein the theoretical lateral-dynamics critical condition is detected if a product of the current steering angle speed and the yaw acceleration is greater than the predefined threshold value.

15. The preventive-action protection system as claimed in claim 12, wherein the current driving-dynamics parameter is an Ackermann lateral acceleration.

16. The preventive-action protection system as claimed in claim 15, wherein a theoretical lateral-dynamics critical condition is detected if a product of the steering angle speed and the Ackermann lateral acceleration is greater than the predefined threshold value.

17. The preventive-action protection system as claimed in claim 12, wherein the predefined threshold value is a function of a vehicle velocity or a gradient of the vehicle velocity.

18. The preventive-action protection system as claimed in claim 12, wherein the predefined threshold value is a function of a coefficient friction of the roadway.

19. The preventive-action protection system as claimed in claim 12, wherein the at least one assigned safety device is actuated as a function of determined physiological variables, including a weight or a body size of a vehicle occupant.

20. The preventive-action protection system as claimed in claim 12, wherein the at least one assigned safety device is actuated as a function of a position of a vehicle occupant.

21. The preventive-action protection system as claimed in claim 12, wherein the at least one assigned safety device is a reversible seatbelt pretensioner.

22. The preventive protection system as claimed in claim 12, wherein the at least one assigned safety device is a movable restraining upholstered element.

23. The preventive-action protection system as claimed in claim 13, wherein the predefined threshold value is a function of a vehicle velocity or a gradient of the vehicle velocity.

24. The preventive-action protection system as claimed in claim 13, wherein the predefined threshold value is a function of a coefficient friction of the roadway.

25. The preventive-action protection system as claimed in claim 13, wherein the at least one assigned safety device is actuated as a function of determined physiological variables, including a weight or a body size of a vehicle occupant.

26. The preventive-action protection system as claimed in claim 13, wherein the at least one assigned safety device is actuated as a function of a position of a vehicle occupant.

27. The preventive-action protection system as claimed in claim 13, wherein the at least one assigned safety device is a reversible seatbelt pretensioner.

28. The preventive protection system as claimed in claim 13, wherein the at least one assigned safety device is a movable restraining upholstered element.

29. The preventive-action protection system as claimed in claim 14, wherein the predefined threshold value is a function of a vehicle velocity or a gradient of the vehicle velocity.

30. The preventive-action protection system as claimed in claim 14, wherein the predefined threshold value is a function of a coefficient friction of the roadway.

31. A method for protecting occupants of a motor vehicle including a preventive-action protection system, comprising:
detecting information with a driving-state sensor system;
comparing the detected information with at least one threshold value to determine a driving state of the motor vehicle; and
actuating at least one safety device assigned to the driving state, if a critical condition of the driving state is detected;
wherein a theoretical, lateral-dynamics critical condition is detected and the at least one assigned safety device is triggered, if a predefined threshold value is exceeded when a current steering angle speed is logically combined with a current driving-dynamics parameter.
